(19) United States
(12) Patent Application Publication
(10) Pub. No.: US 2006/0060543 A1
(43) Pub. Date: Mar. 23, 2006

(54) System and method for the removal of particulates from water

(76) Inventors: David Eric Appleford, Essex (GB); Brian Williams Lane, Essex (GB)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 10/518,169

(22) PCT Filed: Jun. 27, 2003
(86) PCT No.: PCT/GB03/02771

§ 371 Date: Dec. 15, 2004

(30) Foreign Application Priority Data
Jun. 28, 2002 (GB) 0215063.9

(51) Int. Cl. B01D 21/26

(52) U.S. Cl. 210/787

(57) ABSTRACT

An underwater system (1) has a hydrocylone (5) for separating sand from seawater, and a pump (8) downstream from the hydrocylone (5) for drawing seawater upstream of the hydrocylone into the hydrocylone. The sand separated from the seawater is collected in a sand storage device (6) below the hydrocyclone. The pump (8) pumps the seawater from which the sand has been removed into a water injection well (16) and a portion of the seawater is diverted into a sand extraction device (7) beneath the sand storage device (6) to flush away the sand collected therein.

The present invention relates to the removal of particulates from water, particularly in situations when seawater is to be used for injection into a hydrocarbon reservoir.

In an oil and/or gas field development, production fluid, extracted from the hydrocarbon reservoir via production wells, is normally driven to a host facility by the natural pressure of the reservoir. However, the natural pressure varies from field to field and some reservoirs, particularly in later field life, may not have enough natural pressure to drive the production fluid to the host facility.

A way of overcoming this problem is to boost the pressure of the reservoir by injecting seawater, via water injection wells, into the reservoir at a pressure higher than the pressure of the fluid in the reservoir. Where this has been done previously, seawater is pumped from the sea up to a host facility such as a floating platform where it is treated so as to make it suitable for injection into the hydrocarbon reservoir. Such treatment may include both the use of chemicals and particulate removal in a settlement tank to allow suspended sediment to settle and be separated from the seawater. If such sediment is not removed it will cause abrasive wear in equipment and pipelines that the seawater passes through and may adversely affect production from the hydrocarbon reservoir. The substantially sediment free seawater is then pumped from the settlement tank at high pressure down to the water injection wells and into the reservoir.

Pipelines are required to convey the treated water from the host facility to the injection wells and these pipelines have to have a pipe wall thick enough to withstand the high internal pressure of the treated seawater. The capital costs of such pipelines and the installation costs are high.

Thus, the process for injecting seawater into injection wells, requires seawater to be pumped up to a host facility where it is suitably treated before being pumped at high pressure into the wells. This process involves expensive equipment such as high pressure pipelines and pumps. Furthermore, the large amount of energy required to pump the seawater over a long distance from the host facility to the injection wells will increase the running costs.

An object of the invention is to overcome at least some of the problems referred to above.

Thus, according to one aspect of the present invention there is provided a system for use underwater for removing particulates from water, comprising dynamic separating means for removing particulates from water, and pumping means downstream from the dynamic separating means for drawing water upstream of the separating means into the separating means.

The pumping means may be used to inject at least substantially particulate free water from the dynamic separating means into a hydrocarbon reservoir at a pressure higher than the pressure of the fluid in the reservoir.

By providing such a system underwater, the length of high pressure pipelines required between the pumping means and injection wells can be much less than when treated seawater is to be pumped from a host facility. A pump is not required upstream of the separating means to pump water into the separating means (as in the prior art arrangement explained above) and the abrasion problem associated with pumping particulate laden seawater is thereby avoided.

The dynamic separating means may comprise at least one dynamic separator. Such separators are simple, compact, self-contained units which are suitable for use underwater. The dynamic separating means may comprise one or more hydrocyclones.

The system may be provided with means for collecting particulates separated from said water by the dynamic separating means and means for removing collected particulates from the particulate collecting means. The particulate removal means may continuously remove collected particulates or periodically remove collected particulates. Preferably, the system includes means for directing at least some of the at least substantially particulate free water from the dynamic separating means to the particulate removal means to enable the particulate removal means to remove collected particulates. The particulate removal means may comprise a venturi flume.

The system may have a filter upstream of the dynamic separating means for preventing large items such as fish from entering the separating means.

Preferably, the system is incorporated into a retrievable module for use with a modular seabed processing system.

According to another aspect of the present invention there is provided an underwater method for removing particulates from water, comprising the steps of pumping water downstream of dynamic separating means to draw water upstream of the separating means into the separating means, and separating particulates from the water in the dynamic separating means.

The method preferably includes the subsequent step of injecting at least substantially particulate free water from the dynamic separating means into a hydrocarbon reservoir at a pressure higher than the pressure of the fluid in the reservoir.

The invention will now be described, by way of example only, with reference to the accompanying drawings, in which:

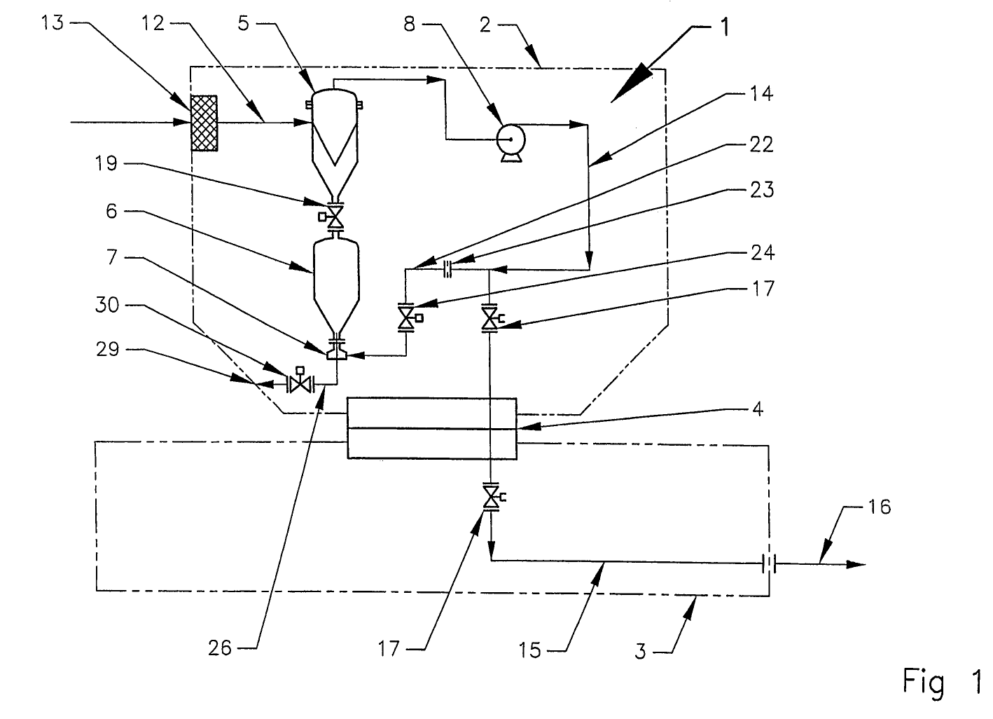

FIG. 1 schematically shows a system in accordance with an embodiment of the present invention;

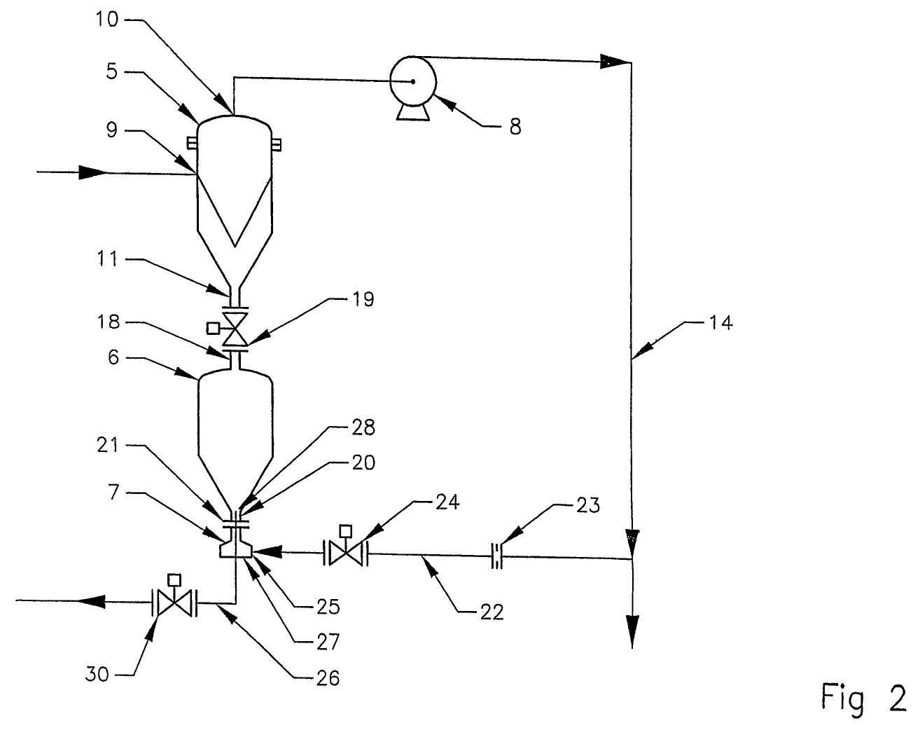

FIG. 2 is a schematic detail of the inside of a module for the system of FIG. 1;

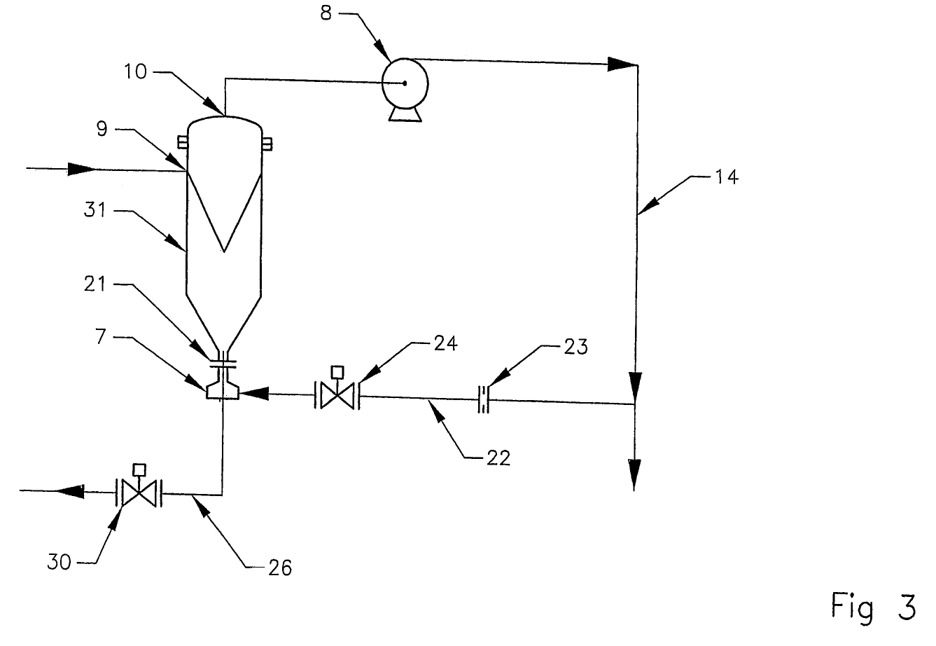

FIG. 3 is a modification of FIG. 2; and

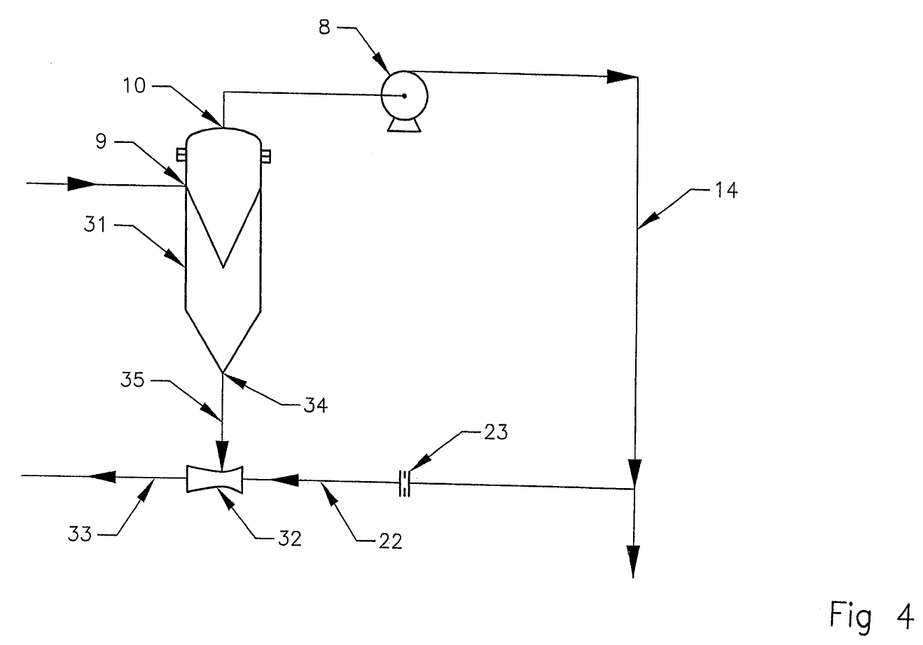

FIG. 4 is a modification of FIG. 3.

Referring to FIGS. 1 and 2 of the accompanying drawings, the system 1 is accommodated in a retrievable module 2 which is connected to a base structure 3 on a seabed by a multi-ported fluid connector 4 for enabling isolation of the module 2 from the base structure 3. The module 2 may be of the general type forming part of a modular system for subsea use designed by Alpha Thames Limited of Essex, United Kingdom, and referred to as AlphaPRIME.

The module 2 contains a sand or particulate or particle removal device 5, a sand storage vessel 6, a dynamic sand extraction device 7, and a pump 8. The sand removal device 5 is a dynamic separator and may be a hydrocyclone separator of the type produced by Axsia Mozley of Redruth, Cornwall, United Kingdom. The sand removal device 5 has a fluid inlet 9, a fluid outlet 10 and a sand or particle outlet 11. The fluid inlet 9 is connected via a fluid inlet conduit 12 to a coarse filter 13 located on an outside face of the module 2, and the fluid outlet 10 is connected to the multi-ported fluid connector 4 by a fluid outlet conduit 14 containing the pump 8. The fluid outlet conduit 14 is connected to a conduit 15 leading to one or more water injection wells (indicated by arrow 16) via the multi-ported fluid connector 4 and each conduit 14,15 includes an isolation valve 17 on either side of the fluid connector 4.

The sand outlet 11 of the sand removal device 5 is connected to a sand inlet 18 of the sand storage vessel 6 below via an actuable isolation valve 19. The vessel 6 has a sand outlet 20 which is connected to the sand extraction device 7 below by a flange connection 21.

The dynamic sand extraction device 7 is connected by a bypass conduit 22 to the fluid outlet conduit 14 downstream of the pump 8 and the bypass conduit 22 has a flow and pressure restriction device 23 and an actuable isolation valve 24 downstream of the device 23. The bypass conduit 22 is connected to a side 25 of the sand extraction device 7 and a sand removal conduit 26 extends through the base 27 of the device 7 and up into the lower portion 28 of the sand storage vessel 6 via the flange connection 21. The sand removal conduit 26 extends in the opposite direction to connect to a port 29 on the side of the module 2, and has an actuable isolation valve 30 between the sand extraction device 7 and the port 29.

The operation of the system 1 will now be described.

The isolation valve 19 between the sand removal device 5 and the sand storage device 6 is set to be open and the isolation valves 24,30 on either side of the sand extraction device 7 are set to be closed. The pump 8 in the module 2 is activated to draw raw seawater into the sand removal device 5 via the coarse filter 13. The flow induced by the pump 8 results in a helical flow being established in the device 5 which leads to the separation of sand and other particulates from the seawater. The sand removal device 5 removes sand and other particulates from the seawater, and the separated sand is collected in the lower portion of the sand storage device 6 therebelow. The pump 8 pumps the seawater separated from the sand via the fluid outlet 10 and the multi-ported fluid connector 4 into the water injection well(s).

Periodically, the sand storage device 6 is flushed. The isolation valve 19 between the sand removal device 5 and the sand storage device 6 is closed and the isolation valves 24,30 on either side of the sand extraction device 7 are opened. A portion of the seawater in the fluid outlet conduit 14 is carried by the bypass conduit 22 into the sand extraction device 7 which causes it to swirl into the lower portion of the sand storage device 6 and flush collected sand into the sand removal conduit 26 and out into the surrounding sea via the port 29.

FIG. 3 illustrates a modification of the system 1 whereby the sand removal device 5 and the sand storage device 6 are replaced by a combined sand removal and storage device 31.

In FIG. 4, the sand removal and storage device 31 is connected to an ejector 32 instead of a sand extraction device 7, and the isolation valves 24,30, which were either side of the sand extraction device 7, are removed. The ejector 32 is a venturi flume and the bypass conduit 22 is connected to the inlet end of it and an outlet conduit 33 connects the other end of it to the module port (not shown). The waist of the venturi flume 32 is connected to the sand outlet 34 of the sand removal and storage device 31 by a sand outlet conduit 35.

The modified system of FIG. 4 is designed to flush sand continuously from the sand removal and storage device 6. Flow of seawater from the bypass conduit 22 through the ejector 32 draws sand down from the sand removal and storage device 6 and the sand and seawater are ejected into the surrounding sea via the port 29.

Whilst embodiments have been described, it will be understood that various modifications may be made without departing from the scope of the invention. For example, for any of the above arrangements the conduit 26,33 to the port 29 may have a one-way valve to prevent seawater surrounding the module 2 from being sucked into the module 2.

The arrangement for removing collected sand illustrated in FIG. 3 may be designed to continuously take separated sand away by removing the isolation valves 24,30 on either side of the sand extraction device 7.

For the above described embodiments, the multi-ported fluid connector 4 may be replaced by a fluid connector with a single bore.

1. An underwater hydrocarbon reservoir water injection system for removing particulates from water, comprising:
separating means for removing particulates from water; and
pumping means downstream from said separating means for drawing surrounding water upstream of said separating means into said separating means;
wherein said system is incorporated into a retrievable module for use with a modular seabed processing system;
wherein said separating means comprises dynamic separating means comprising a hydrocyclone; and
wherein said system further comprises means for collecting particulates separated from said water by said dynamic separating means, means for removing collected particulates from said particulate collecting means and means for directing at least some of the at least substantially particulate free water from said dynamic separating means to said particulate removal means to enable said particulate removal means to remove collected particulates and eject them into water surrounding the module.

2. The system as claimed in claim 1, wherein said pumping means is arranged to inject at least substantially particulate free water from said dynamic separating means into a hydrocarbon reservoir at a pressure higher than the pressure of fluid in said reservoir.

3. The system as claimed in claim 1, including a combined dynamic separating and particulate collecting means.

4. The system as claimed in claim 1, wherein said particulate removal means is arranged to periodically remove collected particulates.

5. The system as claimed in claim 1, wherein said particulate removal means is arranged to continuously remove collected particulates.

6. The system as claimed in claim 1, wherein the particulate removal means comprises a venturi flume.

7. The system as claimed in claim 1, comprising a filter upstream of said dynamic separating means.

8. An underwater method for removing particulates from water and injecting the resulting water into a hydrocarbon reservoir, comprising the steps of:
pumping water downstream of separating means to draw surrounding water upstream of the separating means into the separating means; and
separating particulates from the water in the separating means and injecting the resulting water into a hydrocarbon reservoir;
wherein the separation occurs in a retrievable module for use with a modular seabed processing system, the particulates are separated from the water in dynamic separating means comprising a hydrocyclone and collected in a collecting means, then removed from the collecting means by particulate removal means to which at least some substantially particulate free water from the dynamic separating means is directed to enable the particulate removal means to remove collected particulates and eject them into water surrounding the module.

9. The method as claimed in claim 8, including the subsequent step of injecting at least substantially particulate free water from the dynamic separating means into a hydrocarbon reservoir at a pressure higher than the pressure of fluid in the reservoir.
